(19) United States
(12) Patent Application Publication
(10) Pub. No.: US 2004/0076888 A1
(43) Pub. Date: Apr. 22, 2004

(54) Three-dimensional micropattern

(75) Inventor: Mitsuru Kitamura, Tokyo (JP)

Correspondence Address: SUGHRUE MION, PLLC, 2100 Pennsylvania Avenue, NW, Washington, DC, 20037-3213, US

(73) Assignee: DAI NIPPON PRINTING CO., LTD.

(21) Appl. No.: 10/340,853

(22) Filed: Jan. 10, 2003

(30) Foreign Application Priority Data
Oct. 16, 2002 (JP) 2002-301296

(51) Int. Cl. G03H 1/04

(52) U.S. Cl. 430/1; 430/2; 359/2; 359/23; 359/21

(57) ABSTRACT

The present invention relates to a three-dimensional micropattern using a hologram which can not be counterfeited with color copying machines or diffraction grating image forming devices. The three-dimensional micropattern comprises a hologram composed of a three-dimensional aggregation of a large number of very small micro-letters A-Z or geometric micro-figures. The micro-letters or geometric micro-figures are three-dimensionally aggregated to constitute a three-dimensional object (conical object) to allow reconstruction of a three-dimensional image of the specific three-dimensional object.

### BACKGROUND OF THE INVENTION

The present invention relates to a three-dimensional micropattern, and in particular, a three-dimensional micropattern with enhanced counterfeit deterrent effect using hologram.

Conventionally, micro-letters created by printing have been used in the cash vouchers such as securities and banknotes for counterfeit deterrence. However, due to the improvement of color copying machines in resolution and color reproducibility, counterfeit of these cash vouchers are increasing.

In addition, micro-letters using diffraction gratings have also been practically used for imparting enhanced counterfeit deterrent effect. A security feature using the diffraction grating is often utilized as high level counterfeit deterrence measures because of its high resolution, although it is two-dimensional image. However, these micro-letters using the diffraction grating which have been regarded as high level counterfeit deterrence technique are nowadays increasingly counterfeited, because the patterns recorded in it have come to be detected by microscopic observation, and because of the spread of the diffraction grating image forming devices using laser two-beam interference.

On the other hand, computer generated holograms (CGHs) have been known. There are generally two processes in the CGH producing technique, of which one is a process in which the object surface is replaced with a set of point light sources or linear light sources, known in the non-patent reference 1, 2, and others. The other is the use of the holographic stereogram, known in the patent reference 1 and the non-patent reference 3, and others.

The former process of the two, namely replacing the object surface with a set of point light sources or linear light sources, will be described here as a representative process.

As an example of CGHs, a binary hologram obtained by recording the intensity distribution of interference fringe, of which reconstructed image has parallax only in horizontal direction, and which is to be observed with white light from above, will be described in outline. Referring to FIG. 7, the shape of the object to be imaged in CGH is defined at step ST1. Then at step ST2, the space arrangements of the object, CGH plane, and reference light are defined. Then at step ST3, the object is divided in the vertical direction with horizontal slices, followed by replacement of the sliced surface with a set of point light sources (linear light sources). Then at step ST4, on the basis of these space arrangements, the intensities of the interference fringe between the light arriving from the point light sources (linear light sources) constituting the object and the reference light are calculated for each sample point defined on the CGH plane, thereby obtaining the interference fringe data. Then at step ST5, the obtained interference fringe data are quantized. After that, at step ST6, the data are converted into a rectangular data for EB imaging, which are recorded at step ST7 on a medium by means of an EB imaging device, thus finally producing CGH.

In this calculation of the interference fringe, the hidden surface removal process is performed. The hidden surface removal process is a process of making a part, which is hidden by other object in front of it, invisible when an object is observed from a certain viewpoint, whereby the information of overlapping of objects is added to retina image, thus exhibiting a three dimensional effect. In the CGH recording, the hidden surface removal process is performed according to the following procedure.

As shown in FIG. 8, for each point light source constituting the object 1, the region in which the point light source is hidden by objects 1, 2 (the hatched area in FIG. 8) is obtained. In the case of CGH which is produced according to the procedure shown in FIG. 7, since the objects 1, 2 are sliced by horizontal surfaces and have parallax only in the horizontal direction, the region in which the point light sources on object 1 are hidden by objects 1, 2 is obtained from the positional relations between points and lines on each slice surface. The hidden surface removal process is a process in which, when a sample point of the interference fringe distributing on CGH plane is included in the region in which the point light sources are hidden obtained in the above (solid point in FIG. 8), that point light source at that sample point is eliminated from the calculation of the intensities of the interference fringe. From the image of object 1 reconstructed from CGH processed as above, the reconstruction light is not diffracted to the hatched area in FIG. 8, and the region of the object 1 corresponding to those point light sources becomes invisible because the region becomes behind the image of object 2 when an observer drops his viewpoint on that region.

In addition, it is also proposed in the patent reference 2 that color can be expressed with a CGH, produced by the process in which object surface is replaced by a set of point light sources, by reproducing the CGH with white light.

On the other hand, the inventor has proposed, in Japanese Patent Application No. 2001-365628, “hidden micro-letter” which is recorded in such a manner that a micro-letter providing verifying information is arranged behind a covering object having a size easily recognizable by naked eyes, and the verifying information is hidden by the covering object and is not observable from a predetermined direction, but is observable from the other direction which is different from the predetermined direction, so that the micro-letter is difficult to be detected by counterfeiters. A representative example will be described with reference to FIG. 9. As shown in FIG. 9, verifying information which is a micro-object 11 such as a letter or a figure having such a size as not easily to be recognized by naked eyes, specifically having the largest size not greater than 300 μm, is arranged behind a covering object 12 having a size larger than micro-object 11 and easily recognizable with naked eyes arranged in front of the micro-object (nearer to the observer relative to the micro-object), at a position where micro-object 11 is covered by the covering object when viewed from the front, so that a viewer E can not observe the verifying information from the front (normal observing direction), and this arrangement is recorded in a CGH 10. For this end, the hidden surface removal process described above is performed on the set of point light sources expressing the micro-object 11, and the recording is performed in such a manner that the reconstruction light from the micro-object 11 does not diffract to a region at least between the line 21L and the line 21R in FIG. 9. The line 21L is a line passing the left end of the micro-object 11 and the left end of the covering object 12, and the line 21R is a line passing the right end of the micro-object 11 and the right end of the covering object 12, the front direction being included between the line 21L and the line 21R. In addition, the line 22L is a line drawn from the left end of the micro-object 11 toward upper left indicating a boundary of a region to which the reconstruction light from the left end of the micro-object 11 does not diffract, and the line 22R is a line drawn from the right end of the micro-object 11 toward upper right indicating a boundary of a region to which the reconstruction light from the right end of the micro-object 11 does not diffract.

In relation to the above, the right side emission angle γ₂ of the object light of micro-object 11 is set larger than the angle β₂ which is an angle between the line 21R connecting the right end of the micro-object 11 and the right end of the covering object 12 and the front direction, and the left side emission angle γ₃ of the object light of micro-object 11 is set larger than the angle β₃ which is an angle between the line 21L connecting the left end of the micro-object 11 and the left end of the covering object 12 and the front direction. Accordingly, as seen from FIG. 9, the angle range in which all or a part of the micro-object 11 is visible is γ₂−β₂+γ₃−β₃, while the angle range in which the micro-object is covered is β₂+β₃.

In this type of CGH, the presence of verifying information (micro-object 11) is difficult to be noticed because the recorded verifying information is too small to be recognized with naked eyes even under appropriate illumination. In addition, the presence of the verifying information is difficult to be noticed from the front direction which is the normal observation direction, even with the use of magnifying glass or other enlargement device, thus further enhancing the secrecy of verifying information and decreasing the danger of counterfeit.

In this type of CGH, the verification is performed by irradiating the hologram with appropriate illumination and observing it from a predetermined direction other than the front direction using magnifying glass or other enlargement device to reveal the verifying information (micro-object 11) The verifying information 11 can be confirmed as it disappears because it becomes behind the covering object 12 when the observation position is moved to the front where the observer's direction is the normal observation direction.

[Patent Reference 1]

Japanese patent No. 3,155,263

[Patent Reference 2]

Japanese unexamined patent publication 2000-214751

[Non-Patent Reference 1]

“Image Labo” April 1997 (Vol. 8, No. 4) p. 34-37

[Non-Patent Reference 2]

3D-Image Conference '99 Proceedings CD-ROM (Jun. 30-Jul. 1, 1999 at Kogakuin University Shinjuku Campus) “Image Type Binary CGH by EB Imaging (3)—The Enhancement of Three-Dimensional Effect by Hidden Surface removal/Shadowing”

[Non-Patent Reference 3]

Research Society of Holographic Display (Optical Society of Japan, Japan Society of Applied Physics), The Third Hodic Conference Proceedings (Nov. 15, 1995, at Nihon University Surugadai Campus, Building No. 1, Meeting Room No. 2) “The Speed Up of Two-Dimensional Image Sequence Generation for Holographic Stereogram”

### SUMMARY OF THE INVENTION

As described above, conventional verifying information such as a micro-letter (micropattern) is easily counterfeited and forgery is increasing.

The present invention is made in order to resolve such problems of the prior art, and it is the object of the present invention to provide a three-dimensional micropattern using a hologram which can not be counterfeited by neither of color copying machine nor diffraction grating image forming device.

The three-dimensional micropattern of the present invention which can achieve above described object is characterized by comprising a hologram composed of a three-dimensional aggregation of a large number of very small micro-letters or geometric micro-figures, wherein said micro-letters or geometric micro-figures are three-dimensionally aggregated to constitute a specific three-dimensional object so as to allow reconstruction of a three-dimensional image of the three-dimensional object.

In this connection, it is preferable that the three-dimensional micropattern is recorded as a computer generated hologram. Such computer generated hologram is recorded using a process in which object surface is replaced with a set of point light sources or linear light sources or the holographic stereogram process.

It is preferable that the size of said each very small micro-letter or geometric micro-figure is not greater than 300 μm.

Further, it is preferable that the three-dimensional aggregation of said very small micro-letters or geometric micro-figures is recorded so that the aggregation is reconstructed to compose a specific three-dimensional object as a whole when viewed with naked eyes.

Further, the specific three-dimensional object may be a cylindrical object, a spherical object, a polyhedral object, a conical object, a helical object, a twister-like object.

Furthermore, the micro-letters or geometric micro-figures three-dimensionally aggregated to form the specific three-dimensional object may be spirally arranged around a surface of the specific three-dimensional object.

Moreover, the micro-letters or geometric micro-figures three-dimensionally aggregated to form the specific three-dimensional object may be arranged concentrically around a surface of the specific three-dimensional object or along outlines of pieces created by cutting the specific three-dimensional object.

Among said micro-letters or geometric micro-figures three-dimensionally aggregated to form the specific three-dimensional object, as for the respective configurations, thick ones and thin ones may be mixed.

Further, the micro-letters or geometric micro-figures positioned on the front side of specific three-dimensional object may be formed to have relatively large size.

Further, the micro-letters or geometric micro-figures three-dimensionally aggregated to form the specific three-dimensional object may be recorded in such a manner that they are reconstructed in different colors individually or partially when taken as the aggregation.

In addition, the present invention includes documents on which the three-dimensional micropattern as described above is provided.

The three-dimensional micropattern of the present invention comprises a hologram which is composed of a three-dimensional aggregation of a large number of very small micro-letters or geometric micro-figures and is recorded such that the micro-letters or geometric micro-figures are three-dimensionally aggregated to constitute a specific three-dimensional object so as to allow the reconstruction of a three-dimensional image of the three-dimensional object. Though the three-dimensional object easily recognizable with naked eyes can appear when viewed as a whole, the respective micro-letters or geometric micro-figures constituting the three-dimensional object are hardly recognized, thereby facilitating the verification with naked eyes with keeping the counterfeit deterrent effect. In addition, since the micro-letters or geometric micro-figures are arranged just as being floating in the space, it is extremely difficult to prepare a model of such configuration. Therefore, such micro-letters or geometric micro-figures are hardly counterfeited by means of an ordinary hologram using two-beam interference in which a model is prepared and photographed with laser beams. Since the other micro-letters or geometric micro-figures located in front function as covering object of the micro-letters or geometric micro-figures located inner side of the three-dimensional object, the existence of the hidden micro-letters or geometric micro-figures is difficult to be noticed from normal observation direction even with the use of enlargement means such as magnifying glass, and the information is impossible to be duplicated with color copying machines and further impossible to be counterfeited with diffraction grating image forming devices, thereby significantly enhancing the counterfeit deterrent effect.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a perspective view showing a cylindrical object as one example of three-dimensional images to be used for the three-dimensional micropattern according to the present invention;

FIG. 2 is a perspective view showing a spherical object as one example of three-dimensional images to be used for the three-dimensional micropattern according to the present invention;

FIG. 3 is a perspective view showing a polyhedral object as one example of three-dimensional images to be used for the three-dimensional micropattern according to the present invention;

FIG. 4 is a perspective view showing a conical object as one example of three-dimensional images to be used for the three-dimensional micropattern according to the present invention;

FIG. 5 is a perspective view showing a coil spring-like object as one example of three-dimensional images to be used for the three-dimensional micropattern according to the present invention;

FIG. 6 is a perspective view showing a twister-like object as one example of three-dimensional images to be used for the three-dimensional micropattern according to the present invention;

FIG. 7 is a flow chart schematically showing the procedure of producing CGH according to the process in which object surface is replaced with a set of point light sources or linear light sources;

FIG. 8 is an illustration for explaining the hidden surface removal process of a CGH recording; and

FIG. 9 is an illustration for explaining a micro-object, a covering object, and the range of the object light of a CGH comprising verifying information according to the prior application.

### DESCRIPTION OF THE PREFERRED EMBODIMENTS

Hereinafter, the basic principle and embodiments of the three-dimensional micropattern according to the present invention will be described.

Because micro-letters or geometric micro-figures are so small that constructions of characters or figures are difficultly observed by naked eyes, enhanced counterfeit deterrent effect can be obtained, but there is a problem that verification by naked eyes is also difficult. To solve this problem, according to the present invention, a large number of micro-letters or geometric micro-figures are three-dimensionally arranged spatially in such a manner that these micro-letters or geometric micro-figures compose a three-dimensional object which is easily recognized by naked eyes when taken as a whole, thereby facilitating the verification with naked eyes with keeping the counterfeit deterrent effect of micro-letters or geometric micro-figures.

In addition, since the micro-letters or geometric micro-figures are arranged just as being floating in the space, it is extremely difficult to prepare a model of such configuration. Therefore, such micro-letters or geometric micro-figures are hardly counterfeited by means of conventional-type hologram in which a model is prepared and photographed with laser beams.

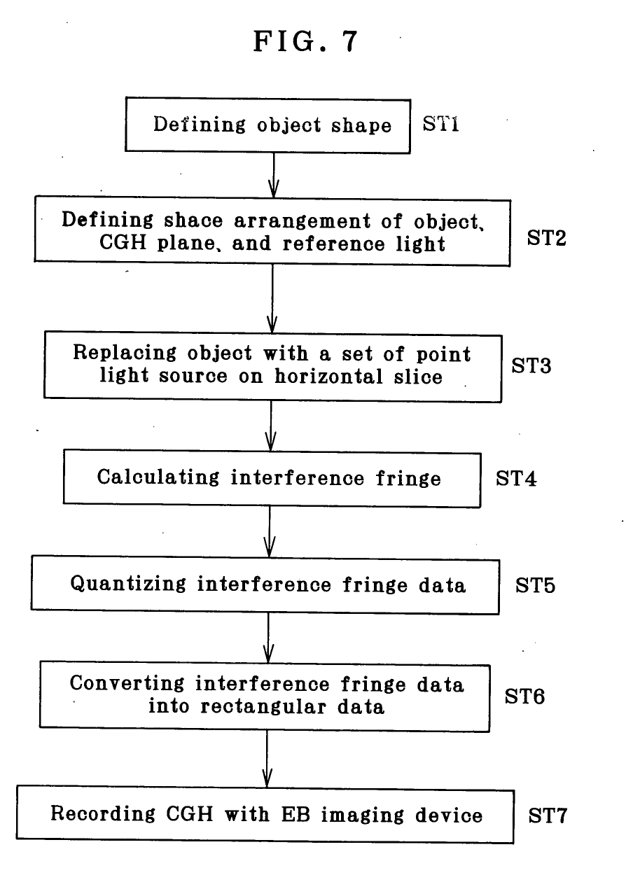

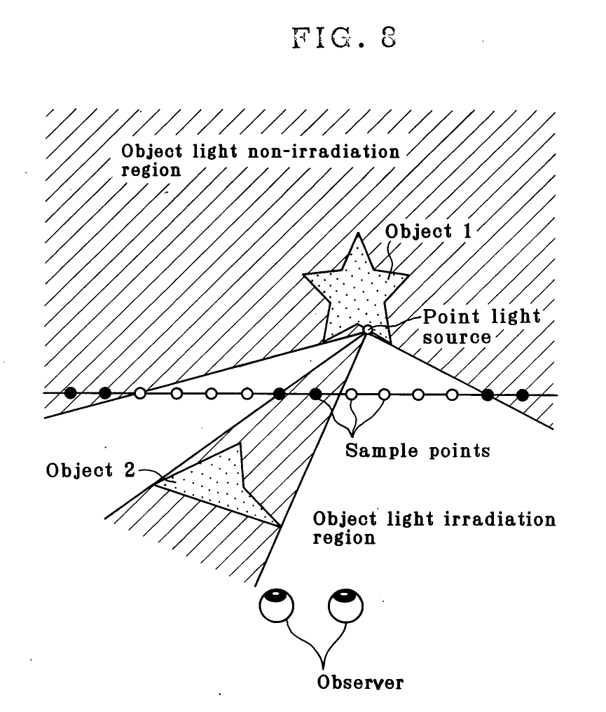

Specifically, for example, at step ST1 in FIG. 7 an original image of three-dimensional micro-letters or geometric micro-figures are precisely created by means of a 3D-CAD for computer graphics in such a manner that these three-dimensional micro-letters or geometric micro-figures compose a three-dimensional structure (three-dimensional object) easily recognizable with naked eyes when taken as a whole. Then at step ST2, the space arrangements of the three-dimensional structure, CGH plane, and reference light are defined. Then at step ST3, the three-dimensional micro-letters or geometric micro-figures are replaced with a set of point light sources or linear light sources, and the hidden surface removal process shown in FIG. 8 is performed. At step ST4, on the basis of these space arrangements, interference fringe data is obtained by calculation of intensities of interference fringe between the light coming from each point light source or linear light source constructing the micro-letters or geometric micro-figures as a three-dimensional structure, and a reference light. Then at step ST5, the obtained interference fringe data are quantized. After that, at step ST6, the data are converted into rectangular data for EB imaging. Then at step ST7, the data is recorded on a medium by an EB imaging device. In this manner, the three-dimensional micropattern of the present invention created utilizing the process in which object surface is replaced with a set of point light sources or linear light sources is produced.

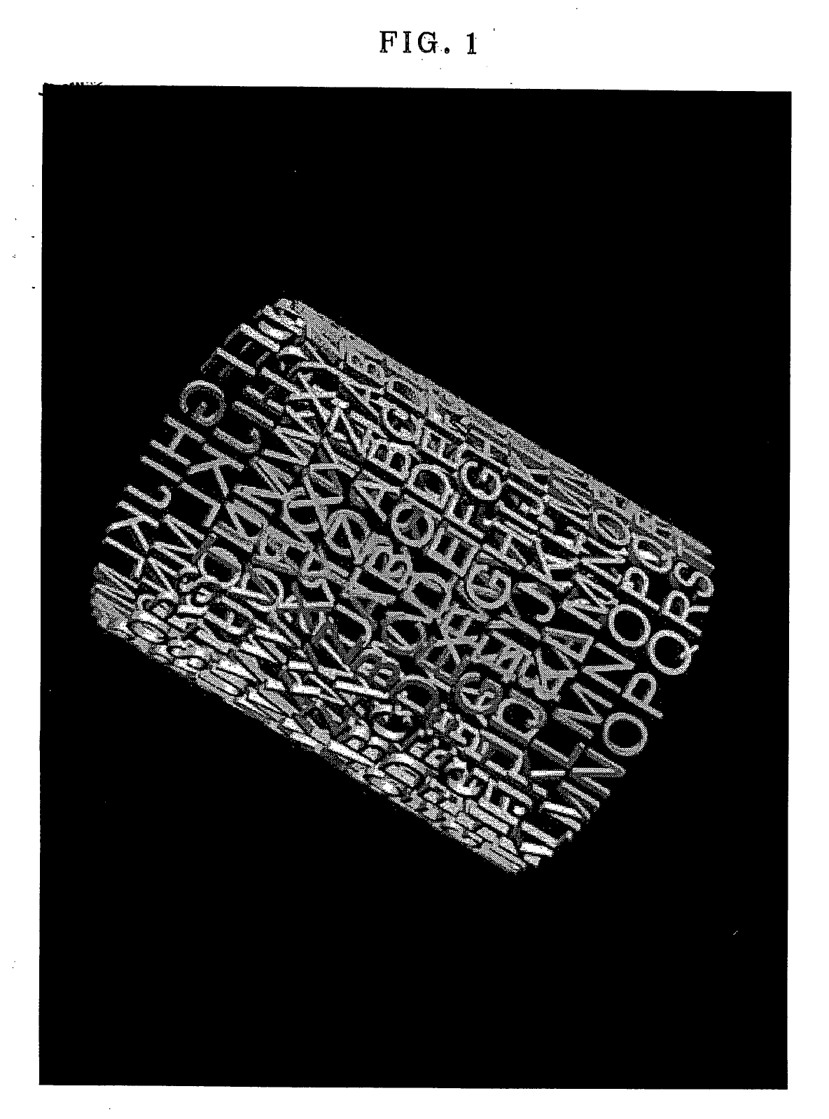

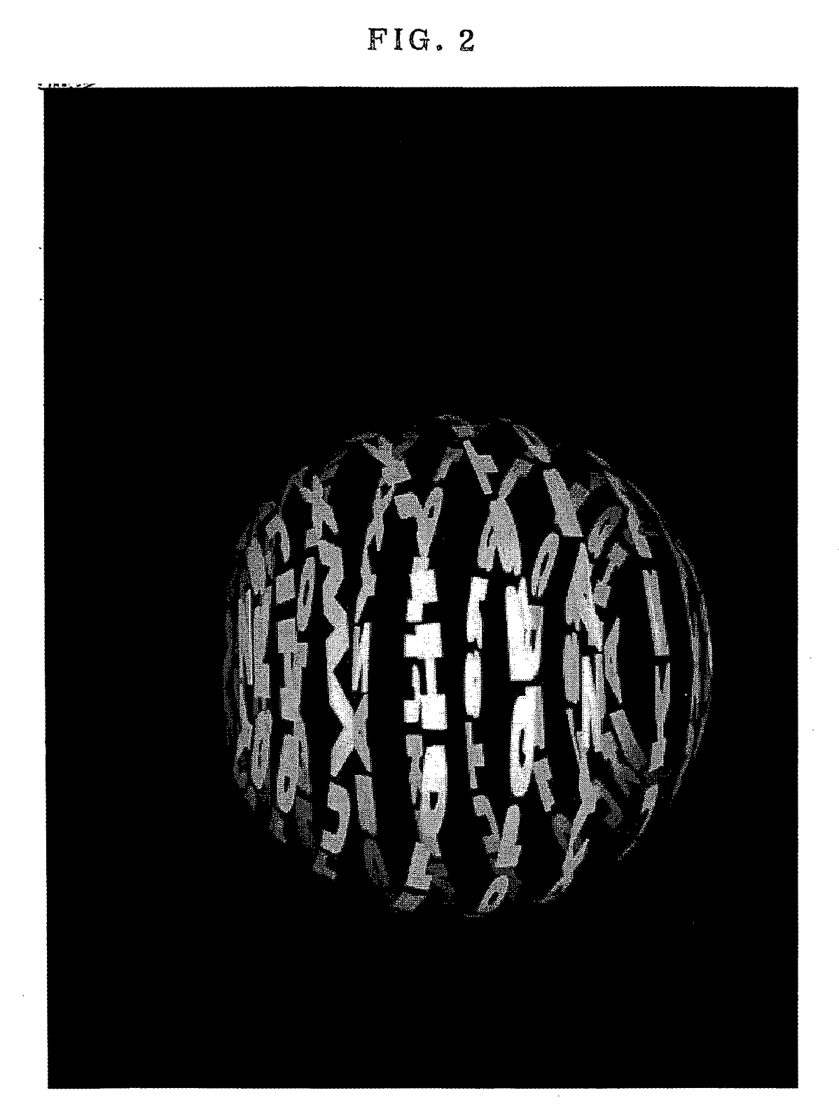

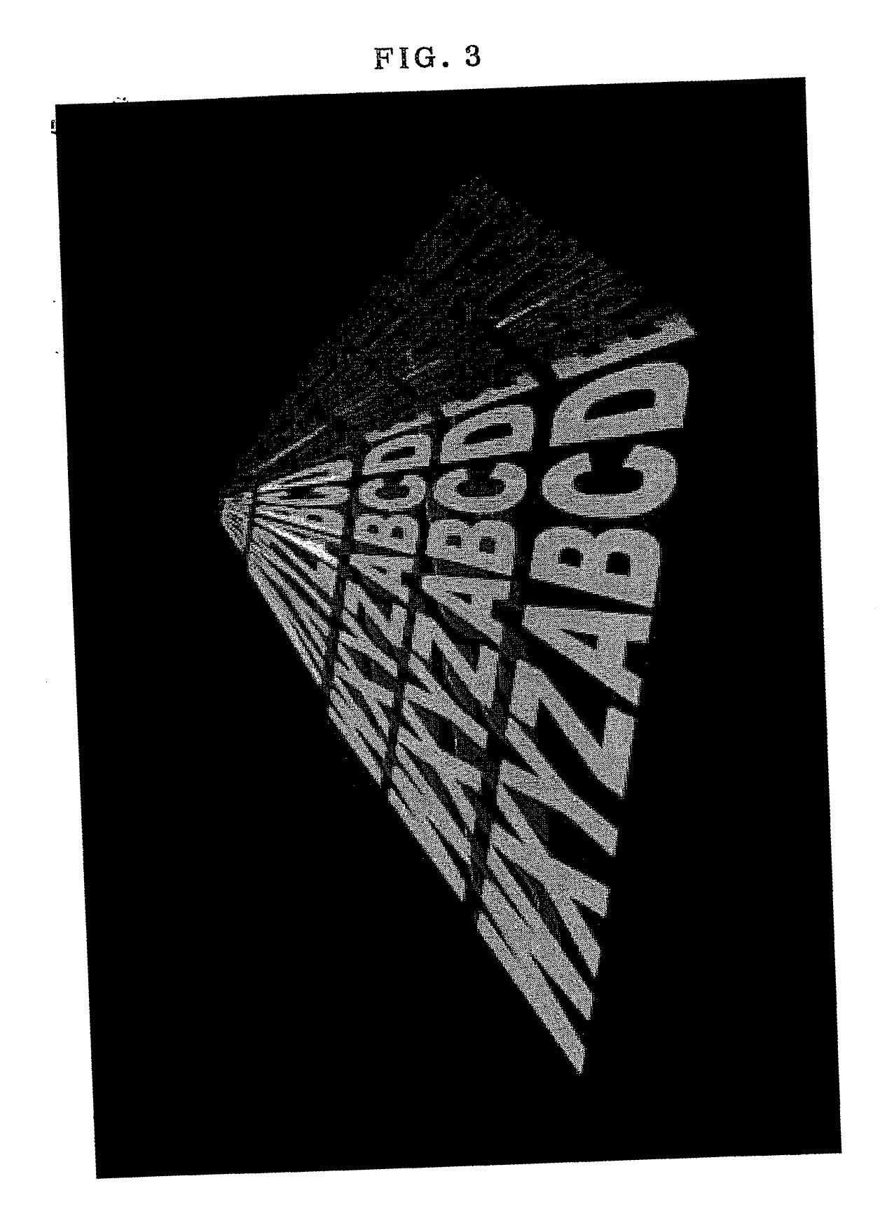

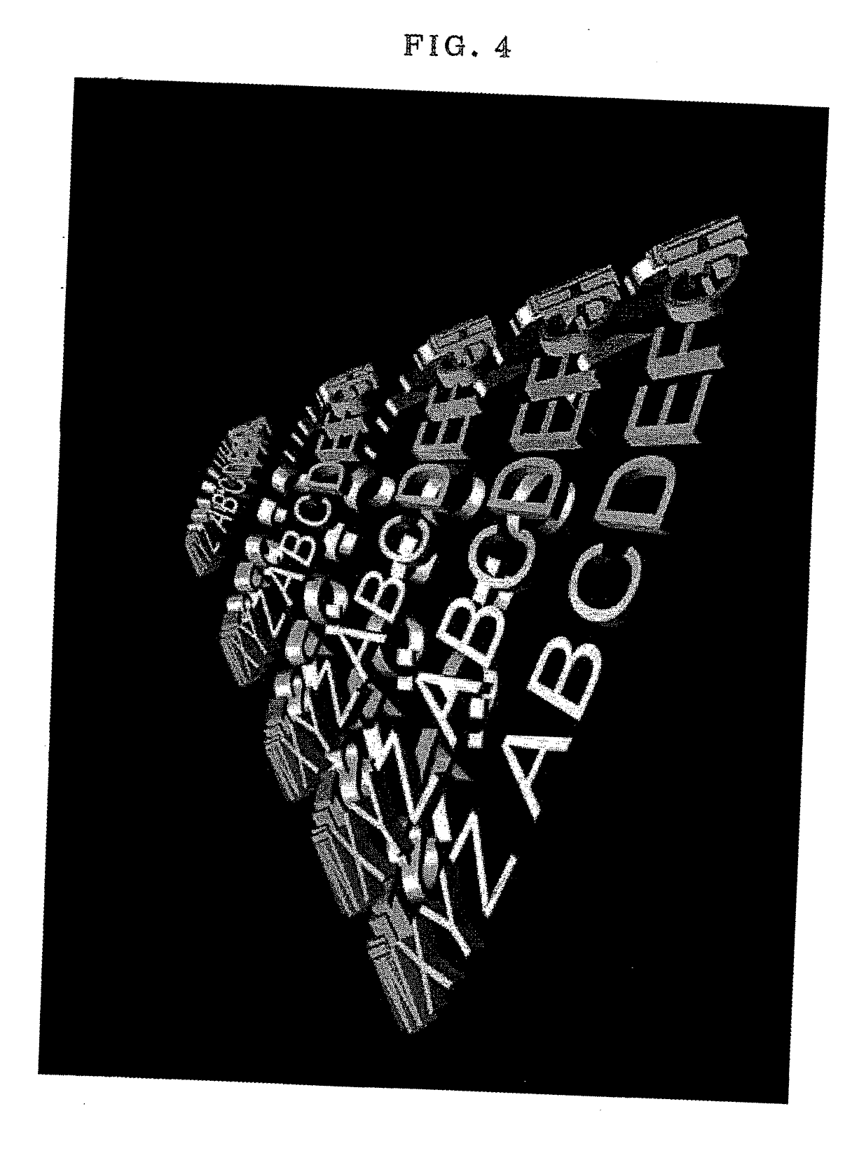

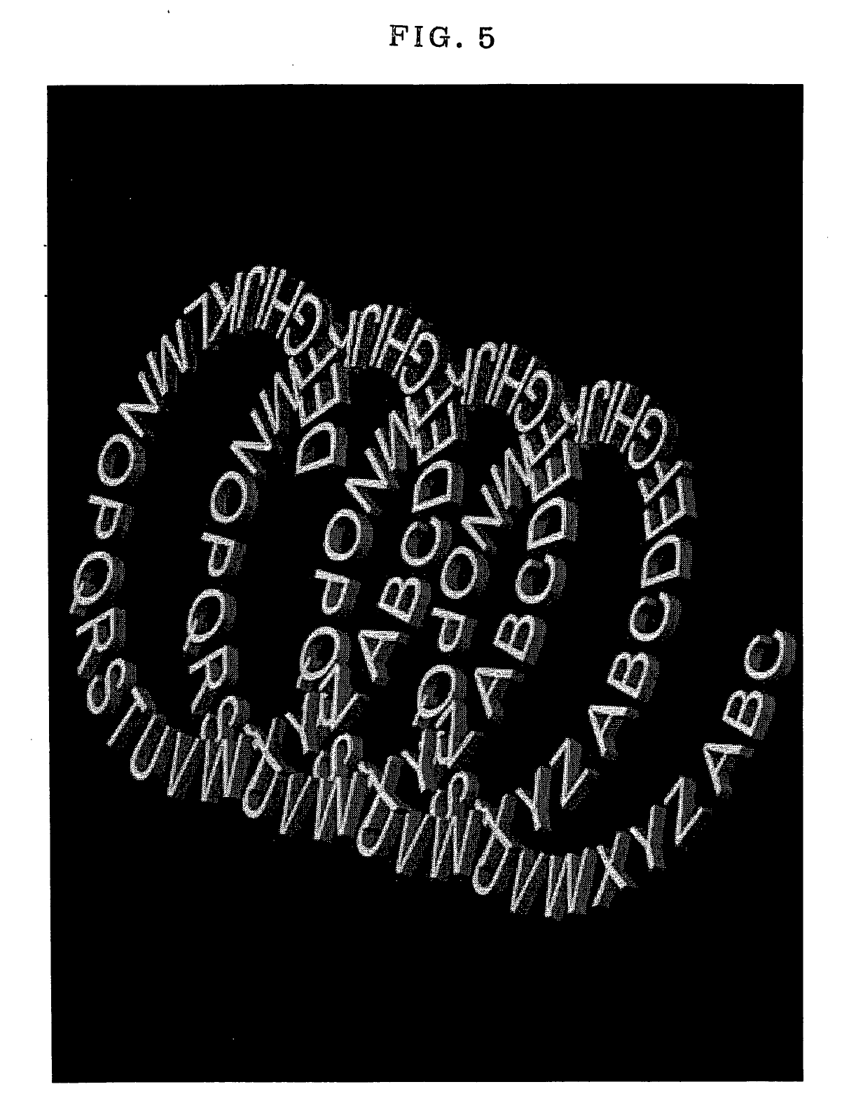

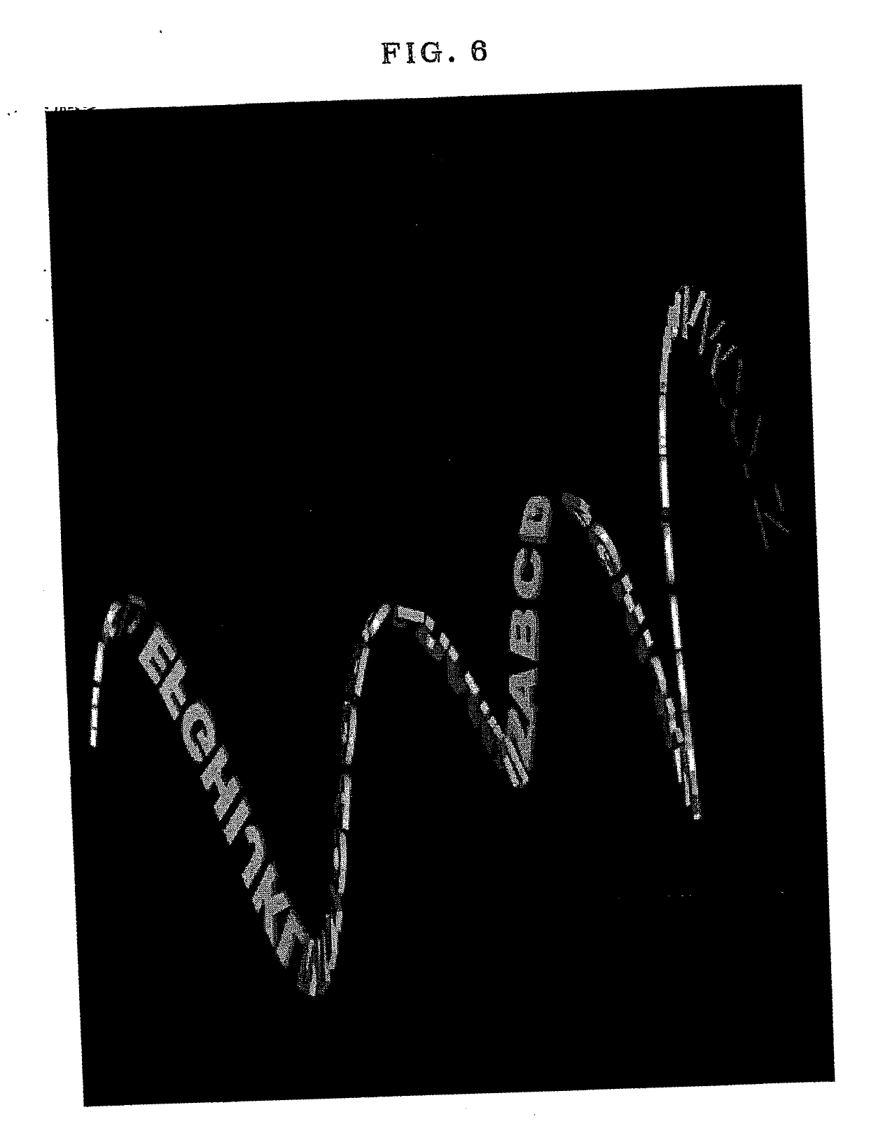

Specific examples of the three-dimensional objects with an arrangement in which a large number of micro-letters or geometric micro-figures are three-dimensionally arranged spatially in such a manner that these micro-letters or geometric micro-figures compose a three-dimensional image which is easily recognized by naked eyes when taken as a whole, are a cylindrical object as shown in FIG. 1, a spherical object as shown in FIG. 2, a polyhedral object (triangular pyramid in the illustrated case) as shown in FIG. 3, a conical object (concentric object) as shown in FIG. 4, a coil spring-like object (spiral object) as shown in FIG. 5, and a twister-like object (with a billowing axis) as shown in FIG. 6.

In case of a cylindrical object as shown in FIG. 1, very small micro-letters of capital letters from A to Z are arranged serially in alphabetical order along outlines of pieces created by cutting a cylindrical object without the top and bottom, in such a manner as to create a peripheral surface of a cylindrical object as a whole.

In case of a spherical object as shown in FIG. 2, very small micro-letters of capital letters from A to Z are arranged, relatively roughly in this case, serially in alphabetical order along outlines of pieces created by cutting a sphere, in such a manner as to create a peripheral surface of a sphere as a whole.

In case of a polyhedral object (tetrahedron) as shown in FIG. 3, very small micro-letters of capital letters from A to Z are arranged serially in alphabetical order along outlines of pieces created by cutting a tetrahedron without its bottom, in such a manner as to create a tetrahedron as a whole. In this case, the nearer to the top of the triangular pyramid, the smaller the size of the micro-letter is.

Also in case of a conical object (concentric object) as shown in FIG. 4, very small micro-letters of capital letters from A to Z are arranged serially in alphabetical order along outlines of pieces created by cutting a circular cone without its bottom, in such a manner as to create a circular cone as a whole. Also in this case, the nearer to the top of the triangular pyramid, the smaller the size of the micro-letter is.

In case of a spiral object as shown in FIG. 5, very small micro-letters of capital letters from A to Z are arranged serially and circularly in alphabetical order along a helical line in such a manner as to create a coil spring-like object as a whole.

In case of a twister-like object as shown in FIG. 6, very small micro-letters of capital letters from A to Z are arranged serially and circularly in alphabetical order along a twister-like line in such a manner as to create a twister-like object as a whole.

In case of any other object as the three-dimensional object than the shapes as shown in FIG. 1 through FIG. 6, very small micro-letters of capital letters from A to Z are arranged serially in such a manner as to create a three-dimensional object easily recognizable with naked eyes. It should be noted that, instead of the micro-letters, geometric micro-figures may be used alone or in combination with micro-letters.

When micro-letters or geometric micro-figures are serially arranged, the case of arranging micro-letters or geometric micro-figures concentrically or along outlines of pieces created by cutting a three-dimensional object is better for imparting the three-dimensional effect than the case of spirally arranging micro-letters or geometric micro-figures around a surface of a three-dimensional object just like the cases of FIG. 5 and FIG. 6.

When among the micro-letters and/or geometric micro-figures used for constituting a three-dimensional object, the respective configurations are different, i.e. thick ones (FIG. 4, FIG. 5) and thin ones (FIG. 2, FIG. 3) are mixed, it is extremely difficult to prepare a model of such the three-dimensional object. Therefore, such micro-letters or geometric micro-figures are hardly counterfeited by means of conventional-type hologram in which a model is prepared and photographed with laser beams.

It is preferable to arrange the micro-letters and/or geometric micro-figures in such a manner that the nearer to the observer the micro-letter or geometric micro-figure is positioned, the larger the size of the micro-letter or geometric micro-figure is. In this arrangement, the sense of depth can be enhanced by perspective effect.

The three-dimensional object easily recognizable with naked eyes is not limited to the examples shown in FIG. 1 through FIG. 6 and may be any of geometric three-dimensional objects. For example, “moiré (wave pattern)” may be employed as the three-dimensional object.

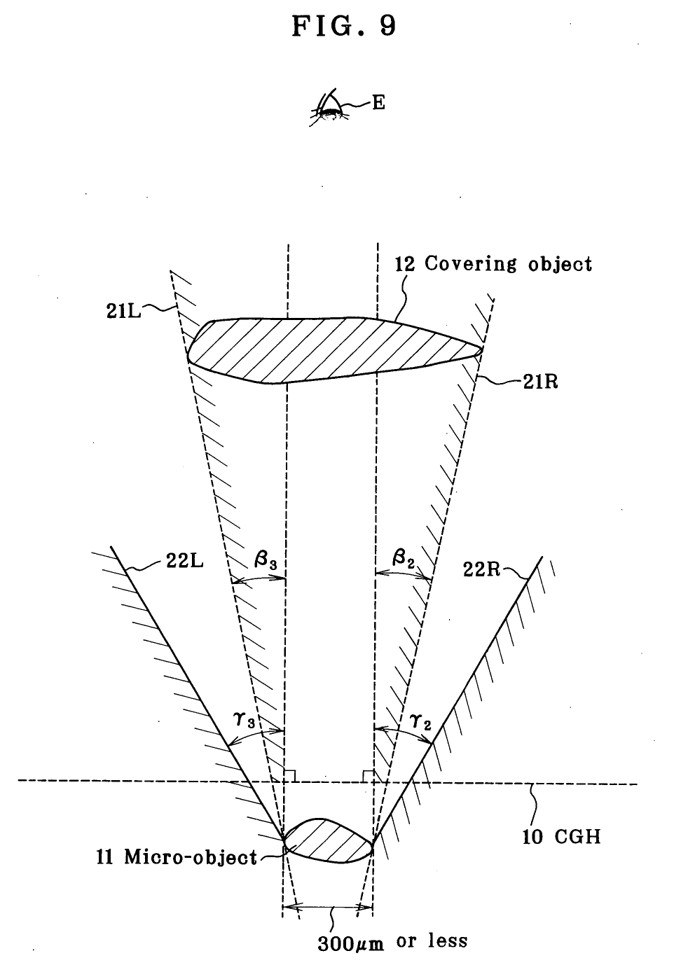

In such constitution, as described with reference to FIG. 9, these micro-letters or geometric micro-figures function as verifying information and other micro-letters or geometric micro-figures, which are located in front of the micro-letters or geometric micro-figures, function as covering object so that the micro-letters or the geometric micro-figures are hidden behind the micro-letters or geometric micro-figures and can not be fully observed in an observation from a predetermined direction, for example from the front direction. However, they may be fully observable from the other direction than the predetermined direction, for example from an oblique direction. In this manner, a three-dimensional micropattern which is more difficult to be counterfeited is achieved, further improving the security.

The micro-letters or geometric micro-figures constituting a three-dimensional object easily recognizable with naked eyes are effective as counterfeit deterrent three-dimensional micropattern when they are recorded with a size difficult to be recognized by naked eyes. Specifically, it is preferable that the size of each micro-letter or geometric micro-figure is not greater than 300 μm.

It is preferable that the micro-letters or geometric micro-figures are recognized with naked eyes as a whole as one three-dimensional object.

Further, it is also preferable that the micro-letters or geometric micro-figures constituting a three-dimensional object are recorded in such a manner that they are reconstructed in different colors. As one of the techniques to achieve this, the process proposed in the patent reference 2 can be employed.

Further, the hologram constituting the three-dimensional micropattern of the present invention can be produced by preparing a model of a three-dimensional object as shown in FIG. 1 through FIG. 6 and photographing the model by an ordinary hologram process using two-beam interference. However, since the sizes of the micro-letters and geometric micro-figures are not greater than 300 μm, the computer generated hologram process as described above is preferable because the ordinary hologram photographing process is difficult to perform for this size.

Further, the three-dimensional micropattern according to the present invention can be constituted as transfer film or label which can be transferred or attached to documents such as securities and banknotes, such documents being included in the range of the present invention.

While the present invention has been described in the above in the context of principle and embodiments thereof, the invention is not limited to these embodiments and various modifications may be made.

As apparent from the above description, according to the three-dimensional micropattern of the present invention, a hologram is composed of a three-dimensional aggregation of a large number of very small micro-letters or geometric micro-figures and is recorded such that the micro-letters or geometric micro-figures are three-dimensionally aggregated to constitute a specific three-dimensional object so as to allow the reconstruction of a three-dimensional image of the three-dimensional object. Though the three-dimensional object easily recognizable with naked eyes can appear when viewed as a whole, the respective micro-letters or geometric micro-figures constituting the three-dimensional object are hardly recognized, thereby facilitating the verification with naked eyes with keeping the counterfeit deterrent effect. In addition, since the micro-letters or geometric micro-figures are arranged just as being floating in the space, it is extremely difficult to prepare a model of such configuration. Therefore, such micro-letters or geometric micro-figures are hardly counterfeited by means of conventional-type hologram using two-beam interference in which a model is prepared and photographed with laser beams. Since the other micro-letters or geometric micro-figures located in front as covering object of the micro-letters or geometric micro-figures located inner side of the three-dimensional object function, the existence of the hidden micro-letters or geometric micro-figures is difficult to be noticed from normal observation direction even with the use of enlargement means such as magnifying glass, and the information is impossible to be duplicated with color copying machines and further impossible to be counterfeited with diffraction grating image forming devices, thereby significantly enhancing the counterfeit deterrent effect.

What is claimed is;

1. A three-dimensional micropattern comprising a hologram composed of a three-dimensional aggregation of a large number of very small micro-letters or geometric micro-figures, wherein said micro-letters or geometric micro-figures are three-dimensionally aggregated to constitute a specific three-dimensional object so as to allow reconstruction of a three-dimensional image of the three-dimensional object.

2. A three-dimensional micropattern as claimed in claim 1, wherein said three-dimensional micropattern is recorded as a computer generated hologram.

3. A three-dimensional micropattern as claimed in claim 2, wherein said three-dimensional micropattern is recorded using a process in which object surface is replaced with a set of point light sources or linear light sources.

4. A three-dimensional micropattern as claimed in claim 2, wherein said three-dimensional micropattern is recorded using the holographic stereogram process.

5. A three-dimensional micropattern as claimed in any one of claims 1 through 4, wherein the size of said each very small micro-letter or geometric micro-figure is not greater than 300 μm.

6. A three-dimensional micropattern as claimed in any one of claims 1 through 5, wherein the three-dimensional aggregation of said very small micro-letters or geometric micro-figures is recorded so that the aggregation is reconstructed to compose a specific three-dimensional object as a whole when viewed with naked eyes.

7. A three-dimensional micropattern as claimed in any one of claims 1 through 6, wherein said specific three-dimensional object is a cylindrical object.

8. A three-dimensional micropattern as claimed in any one of claims 1 through 6, wherein said specific three-dimensional object is a spherical object.

9. A three-dimensional micropattern as claimed in any one of claims 1 through 6, wherein said specific three-dimensional object is a polyhedral object.

10. A three-dimensional micropattern as claimed in any one of claims 1 through 6, wherein said specific three-dimensional object is a conical object.

11. A three-dimensional micropattern as claimed in any one of claims 1 through 6, wherein said specific three-dimensional object is a helical object.

12. A three-dimensional micropattern as claimed in any one of claims 1 through 6, wherein said specific three-dimensional object is a twister-like object.

13. A three-dimensional micropattern as claimed in any one of claims 1 through 12, wherein said micro-letters or geometric micro-figures three-dimensionally aggregated to form the specific three-dimensional object are spirally arranged around a surface of the specific three-dimensional object.

14. A three-dimensional micropattern as claimed in any one of claims 1 through 12, wherein said micro-letters or geometric micro-figures three-dimensionally aggregated to form the specific three-dimensional object are arranged concentrically around a surface of the specific three-dimensional object or along outlines of pieces created by cutting the specific three-dimensional object.

15. A three-dimensional micropattern as claimed in any one of claims 1 through 14, wherein among said micro-letters or geometric micro-figures three-dimensionally aggregated to form the specific three-dimensional object, as for the respective configurations, thick ones and thin ones are mixed.

16. A three-dimensional micropattern as claimed in any one of claims 1 through 15, wherein the micro-letters or geometric micro-figures positioned on the front side of specific three-dimensional object are formed to have relatively large size.

17. A three-dimensional micropattern as claimed in any one of claims 1 through 16, wherein said micro-letters or geometric micro-figures three-dimensionally aggregated to form the specific three-dimensional object are recorded in such a manner that they are reconstructed in different colors individually or partially when taken as the aggregation.

18. A document being provided with a three-dimensional micropattern as claimed in any one of claims 1 through 17.
